(19) United States
(12) Patent Application Publication
(10) Pub. No.: US 2021/0390641 A1
(43) Pub. Date: Dec. 16, 2021

(54) WEB BASED SALES AND RENTAL APPLICATION SUBMISSION AND TRACKING SYSTEM

(71) Applicant: TransAPPtions LLC, Nokomis, FL (US)

(72) Inventors: Charlyn C. Clements, Nokomis, FL (US); Dylan M. Clements, Nokomis, FL (US); Monika G. Sloat-Trujillo, Sarasota, FL (US); Erik R. Sloat, Sarasota, FL (US)

(21) Appl. No.: 17/339,424

(22) Filed: Jun. 4, 2021

Related U.S. Application Data
(60) Provisional application No. 63/039,730, filed on Jun. 16, 2020.

(51) Int. Cl. G06Q 50/16; G07C 13/00; G06Q 10/10

(52) U.S. Cl. CPC G06Q 50/163; G06Q 10/10; G07C 13/00

(57) ABSTRACT

A method and computer system for processing applications for sales and rentals of properties belonging to a community association. A tenant/buyer fills out an online application which is specific to the community association which the property is part of. The system checks the application for completeness, directs the tenant/buyer to upload copies of documents and fill out a background check as needed, and collects an application fee. The application is then forwarded to the landlord/seller for review and signature. Realtors for the tenant/buyer and the landlord/seller are notified if identified. Upon signature of the landlord/seller, the application is forwarded to a community association manager who designates board members to review the application for approval or denial. The board members receive notification of the pending application with supporting documents. The manager then provides final disposition of the application—and the landlord/seller, tenant/buyer and realtors are informed of the denial or approval.

### CROSS-REFERENCE TO RELATED APPLICATIONS

This application claims the benefit of the priority date of U.S. Provisional Patent Application Ser. No. 63/039,730, titled WEB BASED SALES AND RENTAL APPLICATION SUBMISSION AND TRACKING SYSTEM, filed Jun. 16, 2020.

### BACKGROUND

### Field

The present disclosure relates generally to a method and computer system for processing applications for property sales and rentals. More particularly, it relates to a web-based sales and rental application submission and tracking system used by property management companies. The system manages a sales or rental application beginning with a tenant/buyer filling out the application and automatically forwarding it to a landlord/seller who reviews and signs the application, followed by forwarding to a community association manager who obtains approval or denial of the application from board members of the community.

### Discussion of the Related Art

Sales and rental of condominiums and houses which are part of a homeowners association (HOA) or other community association necessarily involve many parties. A landlord/seller lists a property for lease/rental or sale, whereupon a tenant/buyer may be interested in the property. Before the rental or sale transaction can be completed, board members of the HOA or community association must review and approve the proposed transaction. In addition, either the tenant/buyer or the landlord/seller, or both, may have a realtor working on their behalf.

The sale/rental application must be submitted, updated, reviewed and/or approved by each of the parties described above. Although various types of online forms and applications are well known in the art, none have been developed to address the unique needs of sales/rental applications involving HOAs or other community associations. Thus, until now, the processing of applications for property sales and rentals has been done manually, with hardcopies, faxes, scanning/emailing, express shipping of documents, etc. This process is made even more inefficient by the need to look up, at each processing step, the identity and contact information for the next recipient of the application document. There is therefore a great need for an integrated and automated application submission and tracking workflow-based system for property sales and rentals.

### SUMMARY

The present disclosure describes a method and computer system for processing applications for sales and rentals of properties which are part of a community association such as a condominium complex or a homeowners association. A potential tenant/buyer fills out an online application which is specific to the community association which the property is part of. The system checks the application for completeness, directs the tenant/buyer to upload copies of identification documents and fill out a background check as needed, and collects an application fee. The application is then forwarded to the landlord/seller for review and signature. Realtors for the tenant/buyer and the landlord/seller are brought into the loop if identified. Upon signature of the landlord/seller, the application is forwarded to a community association manager who designates community association board members who must review the application for approval or denial, where the designated board members automatically receive notification of the pending application with all supporting documents. Upon receiving answers from the board members, the community association manager provides final disposition of the application—and the landlord/seller, tenant/buyer and realtors are informed of the denial or approval. Approved applications then proceed to closing using normal real estate transaction practices.

Additional features of the present disclosure will become apparent from the following description and appended claims, taken in conjunction with the accompanying drawings.

### BRIEF DESCRIPTION OF THE DRAWINGS

FIG. 1 is a block diagram illustration of a system architecture for a web-based property sales and rentals application processing system known as TransAPPtions, according to an embodiment of the present disclosure; and

FIG. 2 is a flowchart diagram of a method for web-based property sales and rental/lease application processing using the TransAPPtions system, according to an embodiment of the present disclosure.

### DETAILED DESCRIPTION OF THE EMBODIMENTS

The following discussion of the embodiments of the disclosure directed to a method and computer system for web-based property sales and rental application processing is merely exemplary in nature, and is in no way intended to limit the invention or its applications or uses.

The present disclosure describes a web-based system called TransAPPtions which is designed to streamline and simplify the sales and rental/lease process for properties which belong to a community association such as a condominium community or a homeowners association (HOA). Because of the number of parties and reviews/approvals involved in these types of sales and rental/lease transactions, they have until now been very slow and laborious to complete—involving lots of manually completed forms, phone calls, faxes, scanning/emailing, express shipping of documents, etc.

The TransAPPtions system embodies a workflow-based method for completing applications for sale and rental/lease of these types of properties, where all of the documentation and workflow steps are provided in a web-based application (“app”). Role-based security and responsibilities, workflow steps, documentation, notifications, and other parameters are handled in the TransAPPtions system, enabling the parties involved in a particular transaction to easily process and track any application for sale or rental/lease.

Throughout the ensuing discussion of the TransAPPtions system and the associated processes, the following terms and definitions will be used:
Community Association—an association which oversees and manages a group of individually-owned properties; examples of community associations are condominium associations and homeowners associations (for homes in a planned subdivision, for example)
Management Company—a company which manages many community associations
Property Manager—a person who manages the rental of one or more homes in community associations
Landlord/seller—person who owns one or more property in a community association and wishes to put that property up for sale or rental/lease
Tenant/buyer—person who wishes to buy or rent/lease a property in a community association
Community Association Manager—person who manages sales and rental/lease transactions for a community association, but does not have authority to unilaterally approve applications himself/herself
Board Members—people on a Board of the community association who have authority to vote (approve or deny) on proposed sales or lease/rental applications
Realtors—real estate agents for the landlord/seller and/or tenant/buyer who have traditional realtor responsibilities for preparing documents for closing a sale or rental/lease

The process of sales and rental/lease of condominiums and houses which are part of a community association typically involves all of the parties defined above. A landlord/seller lists a property for lease/rental or sale, whereupon a tenant/buyer express interest in the property. Before the rental or sale transaction can be completed, board members of the community association (a HOA or a condominium association) must review and approve the proposed transaction. In addition, either the tenant/buyer or the landlord/seller, or both, may have a realtor working on their behalf. The TransAPPtions system facilitates the submission, tracking and approval of an application, while providing the communication necessary to keep all involved parties apprised of status.

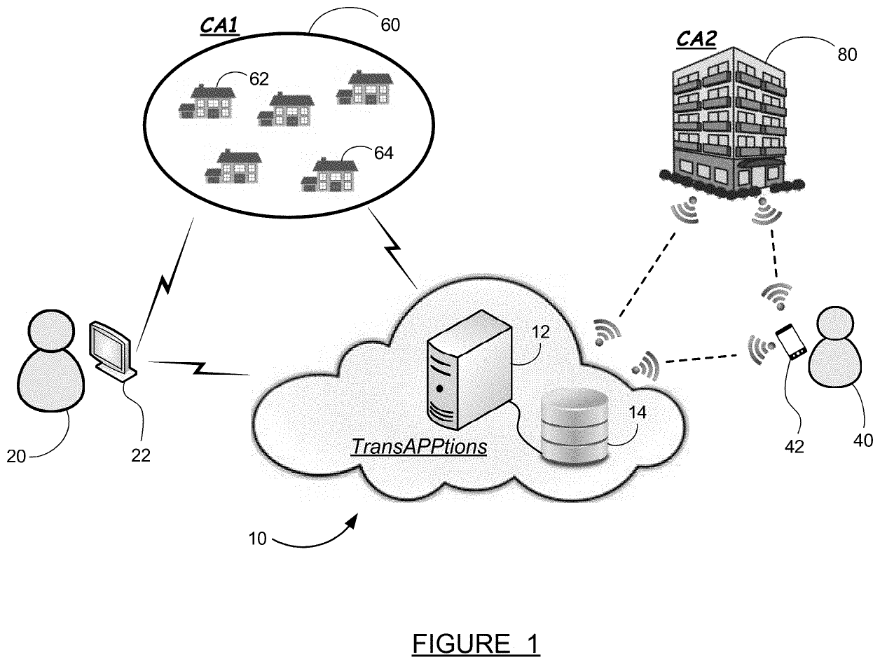

FIG. 1 is a block diagram illustration of a system architecture 10 for the TransAPPtions web-based property sales and rentals application processing system, according to an embodiment of the present disclosure.

TransAPPtions may be used as a web application and/or a mobile “app”. That is, users of TransAPPtions (any/all of the parties described above) may access the application using a web browser on a desktop or laptop computer. The users may also access the application from a mobile device running an app.

A server 12 runs or hosts the TransAPPtions system. The TransAPPtions system on the server 12 has a back-end database 14. The server 12 is typically located “in the cloud”—i.e., managed by a computing services provider and available on the Internet.

Regardless of the hosting arrangement, the TransAPPtions system is accessed by users 20 and 40, representative of all users and all parties involved in the sales and rental/lease application submission and approval process. The user 20 is using a computer 22. The computer 22 is typically a personal computer running web browser software, where the TransAPPtions system is served as web pages from the server 12 to the computer 22 in a known manner. The user 20 may be located at a home or office with a hard-wire connection to the Internet and thus to the server 12. Any individual network connection (local or wide area) between the computer 22 and the cloud (and thereby the server 12) may be hard-wired or wireless.

The user 40 has a mobile device 42. The mobile device 42 wirelessly communicates with the cloud and thus the server 12 in a known manner. The mobile device 42 may run an application program (“app”) specifically designed to interact with the server portion of the TransAPPtions system, also in a manner known to those skilled in the art. The user 40 may also access the TransAPPtions system using web browser software running on the mobile device 42.

Community associations (CAs) such as a first community association CA1 60 and a second community association CA2 80 also interact with the TransAPPtions system. In particular, a person such as a community association manager initially provides information about properties in the community association, and then plays a role in the processing and approval of individual applications for sales and rental/lease, as described in detail below. In the example shown in FIG. 1, the CA1 60 is a subdivision with a homeowners association, and has individual freestanding properties (houses) 62, 64, etc. The CA2 80 is a condominium building having multiple individually-owned units. The users 20 and 40, in the role of the landlord/seller or the tenant/buyer, typically also interact directly with a community association website, such as to identify a property to put up for sale or rental/lease, or to identify a property to buy or rent/lease. These interactions are also discussed below.

Users have roles in the TransAPPtions system, and roles in turn have data access privileges. That is, the data that an individual user can view and/or edit is based on that user's role in the system. For example, users who simply wish to fill out an application for purchase or rental/lease only have access to their own application. Landlords/sellers of a property have access to any application to buy or rent/lease their property. Community association managers have access to all applications in connection with all properties in the community association they manage—including the ability to complete workflow steps for those applications at the appropriate time. This sort of role-based security ensures data integrity in the TransAPPtions system.

In addition to the parties discussed above who each have certain role-based data access rights in the TransAPPtions system, a system administrator manages the TransAPPtions system in its entirety, in a manner known in the art. For example, the system administrator adds new users with an assigned role, such as a community association manager. The system administrator also adds documents and data to the system, such as addresses of properties in a community association which are newly being added into TransAPPtions, and adding the sales/rental application document template for that new community association.

From the preceding discussion, it should be clear that the users 20 and 40 could be persons having any role in the sales/rental application processing process discussed below—including a tenant/buyer, a landlord/seller, a realtor, a community association manager, or a community association board member. Each of these people/roles may have a need to electronically communicate with a community association website and with the TransAPPtions system. The following discussion of the TransAPPtions system methodology (workflow process) describes the interactions that each party has with the TransAPPtions system at each stage of the application submission/approval process, all of which are enabled by the architecture diagram of FIG. 1. The application submission/approval process may be related to a proposed sale, or to a proposed rental/lease; in much of the discussion of the present disclosure, these applications are referred to simply as sales/rental applications.

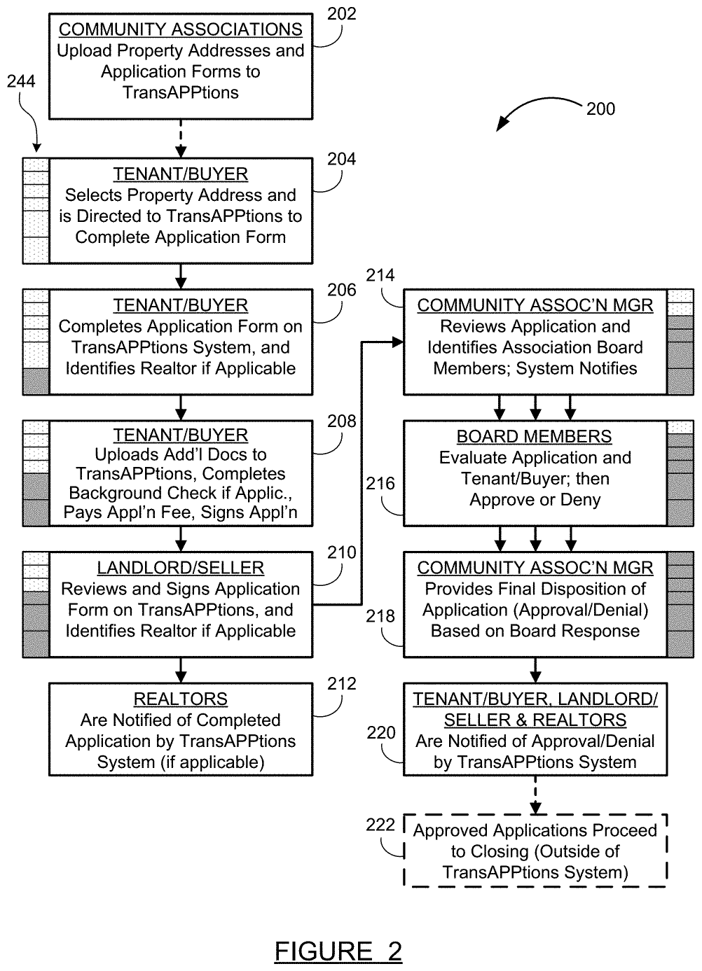

FIG. 2 is a flowchart diagram 200 of a method for web-based property sales and rental/lease application processing using the TransAPPtions system, according to an embodiment of the present disclosure. At box 202, community associations which choose to use the TransAPPtions system provide a list of property addresses which are part of the community association and for which sales/rental applications will be processed using TransAPPtions. Each property address includes contact information for the owner (landlord/seller) so that the application workflow can be processed appropriately. Also, each community association may use its own unique or customized sales/rental application form. Therefore, each community association which chooses to use TransAPPtions provides the application form to be used for that community association, and the application form is converted to a set of database fields provided on a web page (so that it appears to the tenant/buyer as a fillable form) with the corresponding links to the TransAPPtions workflow steps by the TransAPPtions system administrator. Thus, TransAPPtions maintains a database of property addresses, the community association to which each address belongs, and the corresponding application form.

Many community associations will use the TransAPPtions system for processing sales/rental applications. When a property owner wishes to put his/her property up for sale or rental/lease, the property owner may list the property with a realtor, or may place an ad on a “rental by owner” website, for example. The property owner typically also notifies the community association, which normally has its own marketing website for sales and rentals/leases. A prospective buyer or renter/lessee (the tenant/buyer) may learn of the property through any of the above channels. In any case, because the community association controls sales and rentals/leases, the tenant/buyer will be directed to the community association website for details about the property and the community.

If the tenant/buyer is interested in pursuing the purchase or rental/lease, the tenant/buyer will click on an “application” link on the management company or community association website, which will direct the tenant/buyer to the TransAPPtions system to fill out the appropriate application. On the TransAPPtions system, the tenant/buyer enters the address of the property they want to submit an application for, and the TransAPPtions system takes the address given and matches it with the appropriate application form. This step is completed at box 204 of FIG. 2. Also first shown at the box 204 (on the left side) is an “application completion progress meter” 244 which indicates the progress toward completion of the sales/rental application at each step in the process. At the box 204, the tenant/buyer has identified a property and decided to pursue the purchase or rental/lease, and has been directed to the TransAPPtions system, but has not yet begun filling out the application. Thus, the “progress meter” 244 is showing not started.

At box 206, the tenant/buyer completes the application form (which is specific to the community association to which the property belongs)—including typical information such as name and address, contact information, possibly other personal information, dates for rentals, etc. The tenant/buyer also identifies his/her realtor and the realtor's contact information, if the tenant/buyer is working with a realtor. The tenant/buyer also provides the landlord/seller contact information. The tenant/buyer cannot move past the step at the box 206 until the application form is completed and the realtor's name and contact information are provided (if a realtor is indicated as being used).

At box 208, the tenant/buyer uploads additional documents to TransAPPtions, completes a background check request if required by the community association for the type of transaction in question, and pays the application fee. The additional documents that the association(s) require from the tenant/buyer will be noted with areas for them to upload the documents. Examples of this include: a copy of their driver's license, a document stating that they are getting insurance for the unit, a page saying they've read and understand the rules and regulations of the community, etc. The background check form will be attached for the tenant/buyer to complete and electronically sign. The background check form may be automatically forwarded by the TransAPPtions system to the background check company. The TransAPPtions system may only store the last four digits of the tenant/buyer's social security number, for information privacy reasons. Tenants/buyers cannot pay their application fee or submit the application without completing all of the above steps. Again, the steps will be based on the specific requirements of the community association that the property belongs to.

The tenant/buyer needs to be able to electronically sign where necessary; the application, background check form, and understanding of rules and regulations are examples of items that would require a verified electronic signature. The TransAPPtions system may use any known electronic signature system for the electronic signature of the tenant/buyer and other parties as discussed below.

Upon completion of the steps at the box 208, the tenant/buyer has completed his/her portion of the application. At this point, most of the application data and documentation has been provided, but several processing approval steps remain. This is shown in the progress meter (not numbered) for the box 208.

Once the tenant/buyer completes the steps described in the boxes 206 and 208, and submits the application in the TransAPPtions system, a notification (email, or some other type of electronic notification, or a combination thereof) is immediately sent to the property manager (or realtor if applicable), who forwards an email notification to the landlord/seller.

At box 210, the landlord/seller clicks on a link in the email to take him/her to the application in the TransAPPtions system. If the landlord/seller is working with a realtor, then the name and contact information for the realtor must be provided before moving on. The landlord/seller reviews the application form and provides any other necessary information, then electronically signs the application and other forms according to the specific community association requirements. The landlord/seller will not be able to submit the application until all necessary spots have been signed.

At box 212, once the landlord/seller has completed all necessary signatures and submitted the application, a notification is immediately sent (e.g., emailed) to the tenant/buyer's realtor, as well as the landlord/seller's realtor notifying them that the fully executed (but not yet approved) application has been submitted to the community association management company.

When the landlord/seller submits the application at the box 210, the TransAPPtions system also sends an email notification to the manager responsible for the particular community association (to which the property belongs) that they have a new application to review. Each manager/user in the management companies' employment is given their own login information to access their portion of the TransAPPtions portal. The properties they manage are mapped to their ID in the portal. In each manager's portal, they have a section for all pending lease applications, expired leases and active leases, and for open purchase applications and completed purchase applications. These are archived and searchable by fields including; date received, property address, closing date, date sent to board, lease start date, lease end date, owner's name and tenant's name.

At box 214, when notified by TransAPPtions of an application which has been completed through the landlord/seller, the community association manager goes into the system and reviews the application. The manager also enters the community association board members (name and email) to whom the application needs to be forwarded for approval. The board members information is stored for future use, and is also able to be changed when new board members are elected. In one embodiment, one board member is authorized to vote to approve or deny an application, and other board members merely view the application.

At box 216, the board members receive a notification email, which they will open that contains a link to view the pending application and related documentation (such as background check). There will be an approve/deny button for each voting board member to check off, as well as a message section to add any notes. If a board member votes to deny an application, the board member must state a reason in the notes section. When each voting board member processes the application (by clicking either the approve or deny button) a notification will be sent back to the manager notifying him/her of the results.

When the final approval or denial is sent by the board members, the manager will get a notification by email. At box 218, the manager goes into the TransAPPtions system and clicks approved or denied on the application, with an area to add comments. If only one board member is authorized to vote, then the manager does not need to provide the final approval/denial; instead, when the voting board member votes, the TransAPPtions system sends the final approval/denial to all parties. At this point, the application submission and approval process is complete, as indicated by the progress meter for the box 218. At box 220, a notification is sent to the tenant/buyer, the landlord/seller, and the realtors of the board's decision.

When an application is approved by the community association board, the sale or rental/lease can then proceed to completion. This happens in a normal fashion (such as a sale closing arranged by a realtor), and sales are handled outside the TransAPPtions system. Approved leases are automatically filed by the TransAPPtions system for the community association manager. The actual sale or rental/lease transaction is shown, for completeness, at box 222.

The TransAPPtions system includes additional features and functions which are applicable specifically to lease renewals. When a lease application is entered into, the beginning and expiration dates are archived in the manager's portal. 30 days before the lease expiration date, the manager is notified of a lease's upcoming expiration date.

The manager can send an application renewal form to the landlord which contains the association name and property address, original lease dates and terms, with a question of “Will this lease be extended? Yes/No”. If yes is chosen by the landlord, the landlord completes the rest of the form and then submits it. The landlord also enters the name and email of the tenant to be sure it matches and/or is updated in the TransAPPtions system.

When the landlord submits the renewal, a notification is sent to the tenant via email for the tenant to go on the TransAPPtions system and sign the lease renewal. When the tenant submits the renewal, an email notification is sent back to the manager that there is a renewal to review.

The manager reviews the submitted renewal application and forwards the renewal application on to the board. The appropriate board members then approve or deny the renewal application, with the option to leave a message. After the board members submit their approve/deny decisions, the renewal application goes back to the manager who then notifies the tenant, landlord and realtor (using TransAPPtions system notifications), and the lease (if approved) will be archived again for review when the new expiration date is nearing. If there is only a single voting board member, then the TransAPPtions system automatically sends the approval/denial to all parties after the board member votes.

Each of the solid arrows on the flowchart diagram 200 (from the box 204 to the box 206, etc.) represents a workflow step handled by the TransAPPtions system. It should be recognized that these workflow steps include various electronic communications and notifications, including but not limited to emails, text messages, and push notifications from the TransAPPtions system. All of the notifications and user interactions with the TransAPPtions system, described above in relation to FIG. 2, are facilitated by the system and communication architecture shown in FIG. 1.

Other steps and features may implicitly be included in the methods discussed above and supported by the TransAPPtions system. These features include any of the parties accessing the TransAPPtions system at any time to determine the status of an application, among others.

As will be well understood by those skilled in the art, the several and various steps and processes discussed herein to describe the disclosed methods may be referring to operations performed by a computer, a processor or other electronic calculating device that manipulate and/or transform data using electrical phenomenon. In particular, this refers to the server 12, the computer 22 and the mobile device 42 shown in FIG. 1 (“interface devices”), along with computers hosting websites at/for the community associations CA1 and CA2. Those processors and electronic devices may employ various volatile and/or non-volatile memories including non-transitory computer-readable medium with an executable program stored thereon including various code or executable instructions able to be performed by the computer or processor, where the memory and/or computer-readable medium may include all forms and types of memory and other computer-readable media. In particular, the server 12 is understood to be configured to run the TransAPPtions system as described, including managing documents and data, causing workflow steps to be executed, serving out web pages, sending notifications, etc. Further, the server 12, the computer 22 and the mobile device 42 described above are understood to be in communication with each other via any suitable wired or wireless communication channel for the sharing of application screens, input data, output data, etc.

Using the methods and system disclosed above, applications for sale and rental/lease of properties which are part of community associations can be processed in an efficient and orderly manner. The TransAPPtions system enables applications to be completed and approved with no paper documents and no scanning/faxing or mailing, while automatically handling all notifications and workflow steps. These features represent a major improvement over existing manual and paper-based processes.

The foregoing discussion describes merely exemplary embodiments of the present disclosure. One skilled in the art will readily recognize from such discussion and from the accompanying drawings and claims that various changes, modifications and variations can be made therein without departing from the spirit and scope of the invention as defined in the following claims.

What is claimed is:

1. A method for submission and approval of an application for property sale, lease or rental, said method being carried out using software running on a server computer and a plurality of interface devices including personal computers and mobile devices, said method comprising:
completing an application, by a tenant/buyer using one of the interface devices, including identifying a realtor when applicable, uploading copies of required documents, completing a background check form when required, and electronically signing the application;
reviewing and electronically signing the application, by a landlord/seller using one of the interface devices, including identifying a realtor when applicable;
reviewing the application, by a community association manager using one of the interface devices, and identifying community association board members who need to vote on the application;
reviewing the application and voting to approve or deny the application, by the board members each using one of the interface devices; and
reviewing votes of the board members, by the manager using one of the interface devices, and dispositioning the application as either approved or denied based on the votes,
where the server computer stores all applications, documents, signatures, votes and dispositions in a database.

2. The method according to claim 1 wherein the software is a web application or a mobile application served from the server computer via the Internet, and the software is accessed by the tenant/buyer, the landlord/seller, the manager and the board members via web pages or mobile application pages.

3. The method according to claim 1 wherein the server computer sends an electronic notification after each step to a party who is responsible for a next step, and the electronic notification is made by email, or by a push notification sent to a mobile device, or both.

4. The method according to claim 1 further comprising notifying the realtors when the application has been reviewed and signed by the landlord/seller.

5. The method according to claim 1 further comprising notifying the tenant/buyer, the landlord/seller and the realtors when the application has been approved or denied.

6. The method according to claim 1 wherein one or more community associations are defined in the database, where the community associations include subdivisions with a homeowners association and condominiums having multiple individually-owned units in one or more buildings, and each property for sale, lease or rental is part of one of the community associations.

7. The method according to claim 6 further comprising, for each of the community associations, uploading property addresses in the community association to the database, and providing an application template to be used for the sale, lease or rental of all properties in the community association.

8. The method according to claim 1 further comprising, for each previously approved lease, automatically starting a lease renewal process at a prescribed number of days before expiration of the lease.

9. The method according to claim 8 wherein the lease renewal process includes:
notifying the community association manager, by the software, of the upcoming lease expiration;
asking the landlord/seller, by the manager using the software, if the lease is to be renewed;
completing a renewal application, by the landlord/seller, when the lease is to be renewed;
forwarding the renewal application to the board members, by the manager using the system;
voting on the renewal application, by the board members; and
approving the renewal application, by the manager, when the board members vote to approve.

10. A system for submission and approval of an application for property sale, lease or rental, said system comprising:
a server computer including a processor, a memory module, a database and Internet connectivity; and
a plurality of interface devices, including personal computers and mobile devices, each having a processor, memory and Internet connectivity, and being in communication with the server computer,
where the server computer and the interface devices are configured with software to perform property sale, lease or rental application processing using a methodology including steps of;
completing an application, by a tenant/buyer using one of the interface devices, including identifying a realtor when applicable, uploading copies of required documents, completing a background check form when required, and electronically signing the application;
reviewing and electronically signing the application, by a landlord/seller using one of the interface devices, including identifying a realtor when applicable;
reviewing the application, by a community association manager using one of the interface devices, and identifying community association board members who need to vote on the application;
reviewing the application and voting to approve or deny the application, by the board members each using one of the interface devices; and
reviewing votes of the board members, by the manager using one of the interface devices, and dispositioning the application as either approved or denied based on the votes,
where the server computer stores all applications, documents, signatures, votes and dispositions in a database.

11. The system according to claim 10 wherein the software is a web application or a mobile application served from the server computer via the Internet, and the software is accessed by the tenant/buyer, the landlord/seller, the manager and the board members via web pages or mobile application pages.

12. The system according to claim 10 wherein the server computer sends an electronic notification after each step to a party who is responsible for a next step, and the electronic notification is made by email, or by a push notification sent to a mobile device, or both.

13. The system according to claim 10 further comprising a step of notifying the realtors when the application has been reviewed and signed by the landlord/seller.

14. The system according to claim 10 further comprising a step of notifying the tenant/buyer, the landlord/seller and the realtors when the application has been approved or denied.

15. The system according to claim 10 wherein one or more community associations are defined in the database, where the community associations include subdivisions with a homeowners association and condominiums having multiple individually-owned units in one or more buildings, and each property for sale, lease or rental is part of one of the community associations.

16. The system according to claim 15 further comprising, for each of the community associations, a step of uploading property addresses in the community association to the database, and a step of providing an application template to be used for the sale, lease or rental of all properties in the community association.

17. The system according to claim 10 further comprising, for each previously approved lease, a step of automatically starting a lease renewal process at a prescribed number of days before expiration of the lease.

18. The system according to claim 17 wherein the lease renewal process includes:
notifying the community association manager, by the software, of the upcoming lease expiration;
asking the landlord/seller, by the manager using the software, if the lease is to be renewed;
completing a renewal application, by the landlord/seller, when the lease is to be renewed;
forwarding the renewal application to the board members, by the manager using the system;
voting on the renewal application, by the board members; and
approving the renewal application, by the manager, when the board members vote to approve.

19. A non-transitory computer readable medium storing instructions which, when executed, cause a server computer and a plurality of interface devices to perform steps including:
completing an application for property sale, lease or rental, by a tenant/buyer using one of the interface devices, including identifying a realtor when applicable, uploading copies of required documents, completing a background check form when required, and electronically signing the application;
reviewing and electronically signing the application, by a landlord/seller using one of the interface devices, including identifying a realtor when applicable;
reviewing the application, by a community association manager using one of the interface devices, and identifying community association board members who need to vote on the application;
reviewing the application and voting to approve or deny the application, by the board members each using one of the interface devices; and
reviewing votes of the board members, by the manager using one of the interface devices, and dispositioning the application as either approved or denied based on the votes,
where the server computer stores all applications, documents, signatures, votes and dispositions in a database.

20. The non-transitory computer readable medium according to claim 19 wherein the plurality of interface devices includes personal computers and mobile devices, each having a processor, memory and Internet connectivity to the server computer.
